(19) United States
(12) Patent Application Publication
(10) Pub. No.: US 2023/0138999 A1
(43) Pub. Date: May 4, 2023

(54) SOFT ACTUATOR, ARTIFICIAL MUSCLE INCLUDING THE SAME AND ARTIFICIAL MUSCLE DRIVING METHOD USING THE SAME

(71) Applicant: Electronics and Telecommunications Research Institute, Daejeon (KR)

(72) Inventors: Sung Ryul YUN, Daejeon (KR); Inwook HWANG, Daejeon (KR); Hyung Cheol SHIN, Daejeon (KR); Seongcheol MUN, Daejeon (KR); Mi Jeong CHOI, Daejeon (KR)

(73) Assignee: Electronics and Telecommunications Research Institute, Daejeon (KR)

(21) Appl. No.: 17/975,080

(22) Filed: Oct. 27, 2022

(30) Foreign Application Priority Data
Nov. 2, 2021 (KR) 10-2021-0148654
Aug. 9, 2022 (KR) 10-2022-0099414

(51) Int. Cl. A61H 1/02; H02N 10/00

(52) U.S. Cl. CPC A61H 1/0288; H02N 10/00; A61H 2201/12

(57) ABSTRACT

Provided is a soft actuator. The soft actuator includes a first support body, a second support body spaced apart from the first support body in a first direction, a yarn structure having one end coupled to the first support body and the other end coupled to the second support body, and a light source part spaced apart from the yarn structure in a second direction crossing the first direction. The yarn structure includes a polymer layer having a coil spring shape extending in the first direction and a light absorption layer configured to surround an outer surface of the polymer layer.

### CROSS-REFERENCE TO RELATED APPLICATIONS

This U.S. non-provisional patent application claims priority under 35 U.S.C. § 119 of Korean Patent Application Nos. 10-2021-0148654, filed on Nov. 2, 2021, and 10-2022-0099414, filed on Aug. 9, 2022, the entire contents of which are hereby incorporated by reference.

### BACKGROUND

The present disclosure herein relates to a soft actuator, an artificial muscle including the same and an artificial muscle driving method using the same, and more particularly, to a soft actuator capable of being precisely controlled, an artificial muscle including the same, and an artificial muscle driving method using the same.

An artificial muscle refers to a material or device that is artificially created by imitation of a real muscle and exhibits movement in response to stimuli such as a voltage, current, a temperature, and a pressure. Artificial muscle technologies start with a McKibben air muscle, which is contracted and relaxed while supplying compressed air into a tube, and are being developed with various materials, such as a shape memory alloy (SMA), an electroactive polymer (EAP), a yarn-structured polymer nano-material composite, etc., and structures. An electroactive polymer is a material that is moved when a voltage is applied and has various advantages such as a fast response speed, large deformation, low power consumption, and excellent processability, and have principles and characteristics most similar to those of muscles of the human body. Therefore, in spite of a limitation of a low output, the electroactive polymer is widely studied for artificial muscle technologies. The electroactive polymer may be divided into an ionic electroactive polymer (ionic EAP) and a field activated electroactive polymer (field activated EAP) according to an operation method thereof. When a voltage is applied to the ionic polymer, bending deformation (bending) occurs due to a volume difference generated as ions are moved in a direction of an electrode having opposite charges. The field activated EAP may undergo electronic polarization by an applied electric field and deformation by electrostatic force caused by electric charges induced in both electrodes. Among them, a dielectric elastomer is an artificial muscle material that is attracting the most attention for its very large amount of deformation and stress, a fast response speed, durability, and excellent reproducibility compared to other electroactive polymers.

### SUMMARY

The present disclosure provides a soft actuator capable of being precisely controlled, an artificial muscle including the same, and an artificial muscle driving method using the same.

The present disclosure also provides a slim soft actuator having a small volume, an artificial muscle including the same, and an artificial muscle driving method using the same.

The object of the present invention is not limited to the aforesaid, but other objects not described herein will be clearly understood by those skilled in the art from descriptions below.

An embodiment of the inventive concept provides a soft actuator including: a first support body; a second support body spaced apart from the first support body in a first direction; a yarn structure having one end coupled to the first support body and the other end coupled to the second support body; and a light source part spaced apart from the yarn structure in a second direction crossing the first direction, wherein the yarn structure includes: a polymer layer having a coil spring shape extending in the first direction; and a light absorption layer configured to surround an outer surface of the polymer layer.

In an embodiment, the polymer layer may include at least one of nylon, polyvinyl alcohol (PVA), cotton, silk, or cellulose.

In an embodiment, the light absorption layer comprises poly(3,4-ethylenedioxythiophene) (PEDOT) doped with p-toluenesulfonate (PEDOT-Tos).

In an embodiment, the light source part may include a plurality of LED light sources, wherein the plurality of LED light sources may be arranged in the first direction.

In an embodiment, the yarn structure may be provided in plurality, wherein the plurality of yarn structures may be disposed to be spaced apart from each other in a third direction crossing each of the first direction and the second direction.

In an embodiment, the soft actuator may further include a reflective cover extending from the first support body to the second support body, wherein the reflective cover may be configured to surround the yarn structure and the light source.

In an embodiment, the reflective cover may include: an elastic polymer layer configured to define an inner space in which the yarn structure and the light source are disposed; and a light reflective layer on an outer surface of the elastic polymer layer.

In an embodiment, the elastic polymer layer may include polydimethylsiloxane (PDMS).

In an embodiment of the inventive concept, an artificial muscle includes: a soft actuator; and a connection member configured to couple the soft actuator to a human body, wherein the soft actuator includes: a first support body; a second support body spaced apart from the first support body in a first direction; a yarn structure extending from the first support body toward the second support body, the yarn structure having a coil spring shape; and a light source part spaced apart from the yarn structure in a second direction crossing the first direction, wherein the connection member includes: a first connection member coupled to the first support body; and a second connection member coupled to the second support body.

In an embodiment, the yarn structure may include: a polymer layer having a coil spring shape extending in the first direction; and a light absorption layer configured to surround an outer surface of the polymer layer.

In an embodiment, the polymer layer may include at least one of nylon, polyvinyl alcohol (PVA), cotton, silk, or cellulose, and the light absorption layer may include poly(3,4-ethylenedioxythiophene) (PEDOT) doped with p-toluenesulfonate (PEDOT-Tos).

In an embodiment, each of the first connection member and the second connection member may have a ring shape.

In an embodiment, the light source part may include a plurality of LED light sources, wherein the plurality of LED light sources may be arranged in the first direction.

In an embodiment of the inventive concept, an artificial muscle driving method includes: irradiating light to a yarn structure from a light source part; allowing a light absorption layer of the yarn structure to absorb the light so as to generate heat; and heating a polymer layer of the yarn structure by the heat emitted from the light absorption layer to contract a length of the polymer layer, wherein the polymer layer has a coil spring shape extending in a first direction, and the light absorption layer is configured to surround the polymer layer.

In an embodiment, the light source part may be spaced apart from the yarn structure in a second direction crossing the first direction.

In an embodiment, the polymer layer may include at least one of nylon, polyvinyl alcohol (PVA), cotton, silk, or cellulose, and the light absorption layer may include poly(3,4-ethylenedioxythiophene) (PEDOT) doped with p-toluenesulfonate (PEDOT-Tos).

Particularities of other embodiments are included in the detailed description and drawings.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a perspective view of an artificial muscle according to an embodiment of the inventive concept;

FIG. 2 is a front view illustrating a yarn structure of a soft actuator according to an embodiment of the inventive concept;

FIG. 3 is a cross-sectional view of the yarn structure, taken along line I-I′ of FIG. 2;

FIG. 4 is a flowchart illustrating an artificial muscle driving method according to an embodiment of the inventive concept;

FIG. 5 is a perspective view illustrating the artificial muscle driving method according to the flowchart of FIG. 4;

FIG. 6 is a perspective view of an artificial muscle according to an embodiment of the inventive concept;

FIG. 7 is a perspective view of an artificial muscle according to an embodiment of the inventive concept;

FIG. 8 is a cross-sectional view of a soft actuator, taken along line II-IF of FIG. 7; and

FIG. 9 is a perspective view illustrating a state of use of the artificial muscle according to an embodiment of the inventive concept.

### DETAILED DESCRIPTION

Exemplary embodiments of technical ideas of the inventive concept will be described with reference to the accompanying drawings so as to sufficiently understand constitutions and effects of the inventive concept. The technical ideas of the inventive concept may, however, be embodied in different forms and should not be construed as limited to the embodiment set forth herein. Rather, these embodiments are provided so that this disclosure will be thorough and complete, and will fully convey the scope of the present invention to those skilled in the art. Further, the present invention is only defined by scopes of claims.

Like reference numerals refer to like elements throughout. The embodiments in the detailed description will be described with exemplary block diagrams, perspective views, and/or cross-sectional views as ideal exemplary views of the inventive concept. In the figures, the dimensions of regions are exaggerated for effective description of the technical contents. Regions exemplified in the drawings have general properties and are used to illustrate a specific shape of a device. Thus, this should not be construed as limited to the scope of the inventive concept. Also, although various terms are used to describe various components in various embodiments of the inventive concept, the component are not limited to these terms. These terms are only used to distinguish one component from another component. The embodiments described and exemplified herein include complementary embodiments thereof.

In the following description, the technical terms are used only for explaining a specific embodiment while not limiting the present invention. In this specification, the terms of a singular form may comprise plural forms unless specifically mentioned. The meaning of ‘comprises’ and/or ‘comprising’ does not exclude other components besides a mentioned component.

Hereinafter, the present disclosure will be described in detail by explaining preferred embodiments of the technical ideas of the inventive concept with reference to the attached drawings.

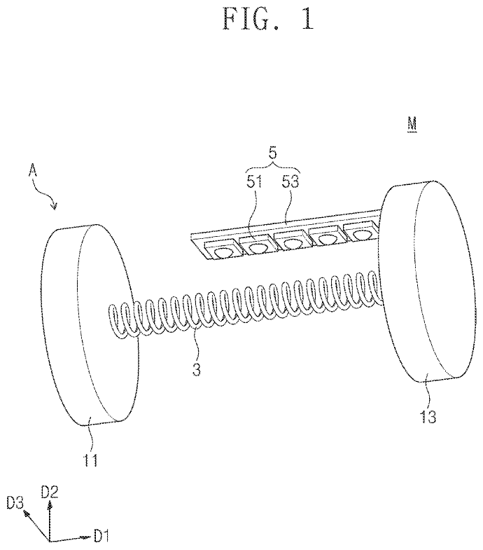

FIG. 1 is a perspective view of an artificial muscle according to an embodiment of the inventive concept.

Hereinafter, a direction D1 in FIG. 1 will be referred to as a first direction, a direction D2 intersecting the first direction D1 will be referred to as a second direction, and a direction D3 intersecting each of the first direction D1 and the second direction D2 will be referred to as a third direction.

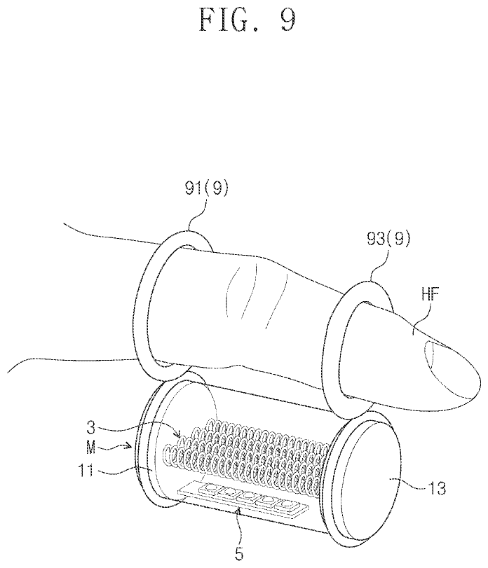

Referring to FIG. 1, an artificial muscle M may be provided. The artificial muscle M may provide power that moves a human body, instead of a portion of human body's muscles. For example, the artificial muscle M may be coupled to a finger of the human body to provide power that moves the finger. However, the embodiment of the inventive concept is not limited thereto, and the artificial muscle M may be coupled to other portions of the human body. The details thereof will be described with reference to FIG. 9.

The artificial muscle M may include a soft actuator A. The soft actuator A may be a device that provides power. More particularly, the soft actuator A may be stretched in the first direction D1 or contracted in the first direction D1. For this, the soft actuator A may include a first support body 11, a second support body 13, a yarn structure 3, and a light source part 5.

The first support body 11 may be connected to one side of the human body. For example, the first support body 11 may be coupled to the human body so as to be fixed to one side of a joint of the human body. The first support body 11 may have a disk shape as illustrated in FIG. 1, but is not limited thereto.

The second support body 13 may be connected to the other side of the human body. For example, the second support body 13 may be coupled to the human body so as to be fixed to the other side of the joint of the human body. The second support body 13 may have a disk shape as illustrated in FIG. 1, but is not limited thereto. The second support body 13 may be spaced apart from the first support body 11. For example, as illustrated in FIG. 1, the second support body 13 may be spaced a predetermined distance from the first support body 11 in the first direction D1.

The yarn structure 3 may connect the first support body 11 to the second support body 13. For example, one side of the yarn structure 3 may be coupled to one surface of the first support body 11, and the other side of the yarn structure 3 may be coupled to one surface of the second support body 13. When the first support body 11 and the second support body 13 are spaced apart from each other in the first direction D1, the yarn structure 3 may extend in the first direction D1. The yarn structure 3 may have a coil spring shape. That is, the yarn structure 3 may have a coil spring shape extending in the first direction D1. The yarn structure 3 may be stretched or contracted. More specifically, the yarn structure 3 may be stretched or contracted so that a length of the yarn structure 3 in the first direction D1 varies. Thus, a distance between the first support body 11 and the second support body 13 may vary. The details thereof will be described later.

The light source part 5 may irradiate light to the yarn structure 3. The light source part 5 may be spaced apart from the yarn structure 3 in a direction crossing the first direction D1. For example, as illustrated in FIG. 1, the light source part 5 may be spaced apart from the yarn structure 3 in the second direction D2. The light source part 5 may include an LED light source 51 and a light source support member 53.

The LED light source 51 may be disposed to face the yarn structure 3. For example, as illustrated in FIG. 1, the LED light source 51 may be disposed in a direction opposite to the second direction D2. The LED light source 51 may irradiate light toward the yarn structure 3. A temperature of at least a portion of the yarn structure 3 may increase by the light irradiated by the LED light source 51. The LED light source 51 may be provided in plurality. The plurality of LED light sources 51 may be arranged along the extension direction of the yarn structure 3. For example, the plurality of LED light sources 51 may be arranged in the first direction D1. However, hereinafter, for convenience, the LED light source 51 will be described in the singular.

The light source support member 53 may support the LED light source 51. The light source support member 53 may be connected to the first support body 11 or the second support body 13. For example, as illustrated in FIG. 1, the light source support member 53 may extend from the second support body 13 in a direction opposite to the first direction D1.

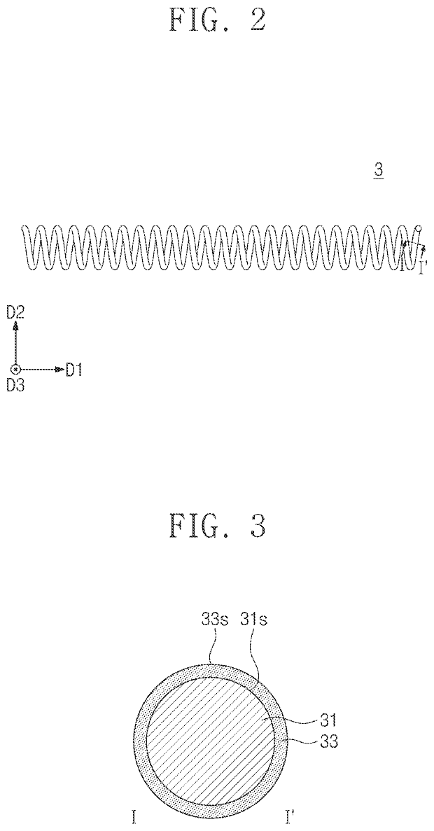

FIG. 2 is a front view illustrating the yarn structure of the soft actuator according to an embodiment of the inventive concept, and FIG. 3 is a cross-sectional view of the yarn structure, taken along line I-I′ of FIG. 2.

Referring to FIGS. 2 and 3, the yarn structure 3 may include a polymer layer 31 and a light absorption layer 33.

The polymer layer 31 may have a coil spring shape. More specifically, the polymer layer 31 illustrated in FIG. 3 may have a coil spring shape extending in the first direction D1 as illustrated in FIG. 2. The polymer layer 31 may include a polymer fiber material. For example, the polymer layer 31 may include at least one of nylon, polyvinyl alcohol (PVA), cotton, silk, or cellulose. However, the embodiment of the inventive concept is not limited thereto, and the polymer layer 31 may include other types of materials, which vary in volume according to a temperature.

The light absorption layer 33 may surround the polymer layer 31. More specifically, the light absorption layer 33 may surround an outer surface 31s of the polymer layer 31 as illustrated in FIG. 3. That is, the light absorption layer 33 may be in contact with the outer surface 31s of the polymer layer 31. When the polymer layer 31 has a coil spring shape extending in the first direction as illustrated in FIG. 2, the light absorption layer 33 surrounding the polymer layer 31 may also have a coil spring shape similar to that of the polymer layer 31. The light absorption layer 33 may absorb light. For example, when light is irradiated to an outer surface 33s of the light absorption layer 33, the light absorption layer 33 may absorb the light. Thus, a temperature of the light absorption layer 33 may increase. For this, the light absorption layer 33 may include a material of which a temperature varies by absorbing the light. For example, the light absorption layer 33 may include poly(3,4-ethylenedioxythiophene) (PEDOT) doped with p-toluenesulfonate (PEDOT-Tos). However, the embodiment of the inventive concept is not limited thereto, and the light absorption layer 33 may include other types of materials capable of absorbing light. The light absorption layer 33 may be formed through various methods. For example, the light absorption layer 33 may be applied on the outer surface 31s of the polymer layer 31 through a spray coating and/or dip-coating process. However, the embodiment of the inventive concept is not limited thereto, and the light absorption layer 33 may be formed through other processes.

The details on a function of the yarn structure 3 will be described later.

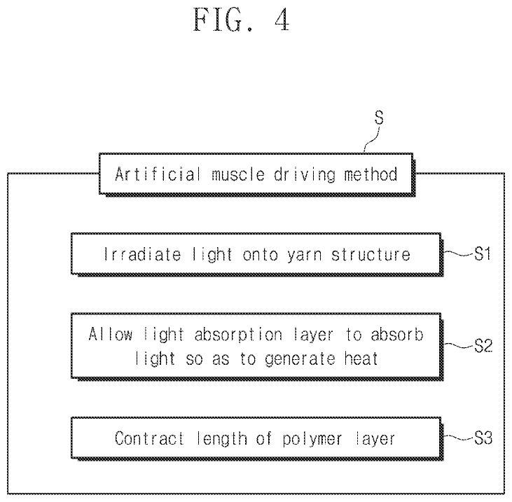

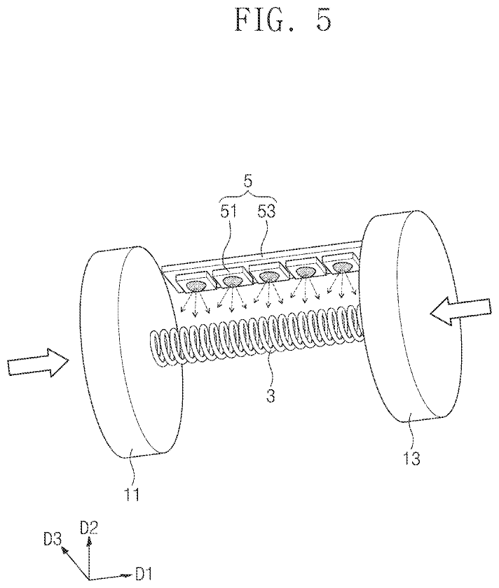

FIG. 4 is a flowchart illustrating an artificial muscle driving method according to an embodiment of the inventive concept.

Referring to FIG. 4, an artificial muscle driving method S may be provided. The artificial muscle driving method S may be a method of driving the artificial muscle M described with reference to FIGS. 1 to 3. The artificial muscle driving method S may include a process (S1) of irradiating light to a yarn structure, a process (S2) of allowing a light absorption layer to absorb light so as to generate heat, and a process (S3) of allowing a polymer layer to be contracted in length.

Hereinafter, the artificial muscle driving method S of FIG. 4 will be described with reference to FIGS. 5 and 3.

FIG. 5 is a perspective view illustrating the artificial muscle driving method according to the flowchart of FIG. 4.

Referring to FIGS. 5, 3 and 4, the process (S1) of irradiating light to the yarn structure may include a process of allowing a light source part 5 to irradiate light to the yarn structure. That is, the light emitted from the LED light source 51 may be irradiated to the yarn structure 3. When the LED light source 51 is provided in plurality, light may be emitted from each of the plurality of LED light sources 51 so as to be irradiated to the yarn structure 3. The light emitted from the LED light source 51 may be irradiated to an outer surface 33s of a light absorption layer 33.

The light absorption layer absorbing light to generate heat (S2) may include absorbing light irradiated to the outer surface 33s of the light absorption layer 33 by the light absorption layer 33. When the light absorption layer 33 absorbs the light, a temperature of the light absorption layer 33 may increase. When the temperature of the light absorption layer 33 increases, the light absorption layer 33 may radiate heat to the surroundings. That is, due to a photo-thermal effect, the light absorbed by the light absorption layer 33 may be used to radiate heat to the surroundings. At least a portion of the heat emitted from the light absorption layer 33 may be transferred to a polymer layer 31.

The process (S3) of allowing the polymer layer to be contracted in length may include a process of heating the polymer layer 31 by the heat emitted from the light absorption layer 33. When the polymer layer 31 is heated by the heat, the temperature of the polymer layer 31 may increase. When the temperature of the polymer layer 31 increases, the polymer layer 31 may be expanded. More specifically, as the temperature of the polymer layer 31 increases, the polymer layer 31 may be expanded in a thickness direction. That is, the polymer layer 31 may be expanded so that a cross-sectional area of the polymer layer 31 as illustrated in FIG. 3 is widened. When the polymer layer 31 is expanded in the thickness direction, a length of the polymer layer 31 may be contracted. That is, the length of the polymer layer 31 in the first direction D1 may be reduced. When the length of the polymer layer 31 is contracted, a gap between the first support body 11 and the second support body 13 may be narrowed. That is, the first support body 11 and the second support body 13 may approach each other. Thus, the entire soft actuator A may be contracted.

In the above description, the soft actuator A is used for an artificial muscle M, but is not limited thereto. That is, the soft actuator A may be applied to other technical fields other than the artificial muscle.

According to the soft actuator, the artificial muscle including the same, and the artificial muscle driving method using the same according to embodiments of the inventive concept, the soft actuator may operate using the light source. Therefore, the soft actuator may be reduced in volume and lighten in weight. Therefore, when the soft actuator is applied to the artificial muscle, a burden on the human body may be reduced.

According to the soft actuator, the artificial muscle including the same, and the artificial muscle driving method using the same according to embodiments of the inventive concept, the yarn structure may be contracted using the light source, and thus, the soft actuator may be precisely driven. That is, an intensity of light irradiated from the light source may be adjusted to control a degree of deformation of the soft actuator. Since the degree of deformation of the soft actuator is controlled using the intensity of light, the soft actuator may be precisely controlled. Therefore, the control precision of the artificial muscle may be improved.

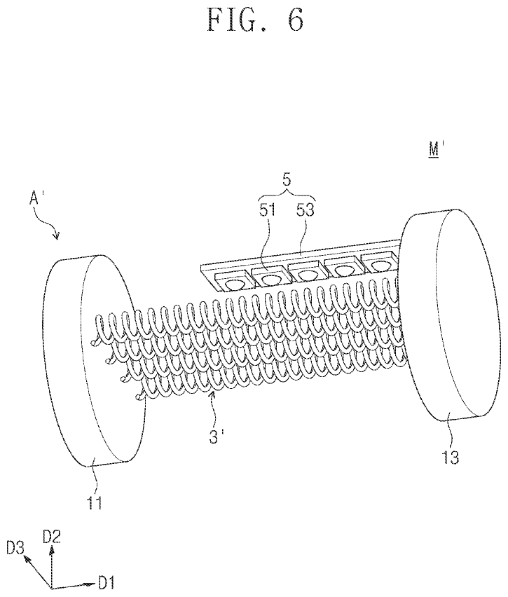

FIG. 6 is a perspective view of an artificial muscle according to an embodiment of the inventive concept.

Hereinafter, descriptions of contents substantially the same as or similar to those described with reference to FIGS. 1 to 5 may be omitted.

Referring to FIG. 6, an artificial muscle M′ may be provided. The artificial muscle M′ may include a soft actuator A′. However, unlike that described with reference to FIG. 1, the soft actuator A′ of FIG. 6 may include a plurality of yarn structures 3′. For example, four yarn structures 3′ may be provided as illustrated in FIG. 6. However, the embodiment of the inventive concept is not limited thereto, and the number of yarn structures 3′ may be applied differently according to a specific design. The plurality of yarn structures 3′ may be spaced apart from each other in the third direction D3.

According to the soft actuator, the artificial muscle including the same, and the artificial muscle driving method using the same according to embodiments of the inventive concept, contractile force of the soft actuator may be improved by using the plurality of yarn structures. That is, when a sufficient output is not secured with only one yarn structure, a plurality of yarn structures may be applied. In this way, the output of the soft actuator may be adjusted.

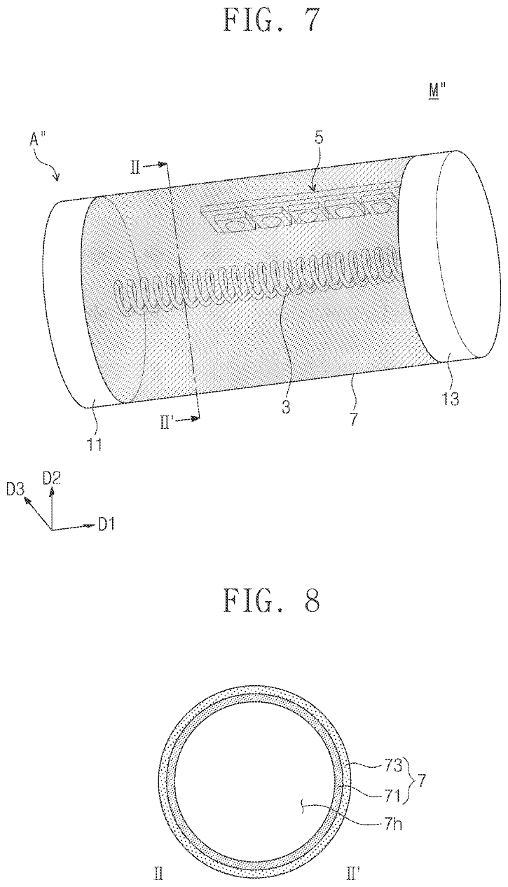

FIG. 7 is a perspective view of an artificial muscle according to an embodiment of the inventive concept, and FIG. 8 is a cross-sectional view of a soft actuator, taken along line II-II′ of FIG. 7.

Hereinafter, descriptions of contents substantially the same as or similar to those described with reference to FIGS. 1 to 6 may be omitted.

Referring to FIGS. 7 and 8, an artificial muscle M″ may be provided. The artificial muscle M″ may include a soft actuator A″. However, unlike that described with reference to FIG. 1, the soft actuator A″ of FIG. 7 may further include a reflective cover 7.

The reflective cover 7 may surround a light source 5 and a yarn structure 3. In embodiments, the reflective cover 7 may extend from a first support body 11 to a second support body 13. That is, the reflective cover 7 may extend from the first support body 11 in the first direction D1 so as to be connected to the second support body 13. The reflective cover 7 may reflect light. More specifically, the reflective cover 7 may reflect light that is not absorbed by the yarn structure 3 among the light irradiated from the light source part 5. For this, the reflective cover 7 may include an elastic polymer layer 71 and a light reflective layer 73.

The elastic polymer layer 71 may provide an inner space 7h. The yarn structure 3 and/or the light source part 5 may be disposed in the inner space 7h. A length of the elastic polymer layer 71 in the first direction D1 may vary. That is, when the first support body 11 and the second support body 13 are closer to each other due to the contraction of the yarn structure 3, the length of the elastic polymer layer 71 in the first direction D1 may vary. For this, the elastic polymer layer 71 may include a contractible material. For example, the elastic polymer layer 71 may include polydimethylsiloxane (PDMS). However, the embodiment of the inventive concept is not limited thereto, and the elastic polymer layer 71 may include other materials having a variable length.

The light reflective layer 73 may be disposed on an outer surface of the elastic polymer layer 71. More specifically, the light reflective layer 73 may surround the elastic polymer layer 71. The light reflective layer 73 may be formed on the elastic polymer layer 71 through various methods. For example, the light reflective layer 73 may be formed on the elastic polymer layer 71 through a process such as bar coating, meniscus dragging deposition (MDD), spray coating, evaporation, or sputtering. The light reflective layer 73 may include a material capable of reflecting light. More specifically, the light reflective layer 73 may include a thin metal material capable of reflecting visible light and/or infrared light.

According to the soft actuator, the artificial muscle including the same, and the artificial muscle driving method using the same according to embodiments of the inventive concept, the reflective cover including the light reflective layer may surround the yarn structure and the light source part. The light that is not absorbed by the yarn structure in the light irradiated from the light source may be reflected by the light reflective layer and then irradiated again to the yarn structure. Thus, an amount of light absorbed by the yarn structure may increase. Thus, energy efficiency may be improved.

FIG. 9 is a perspective view illustrating a state of use of the artificial muscle according to an embodiment of the inventive concept.

Referring to FIG. 9, the artificial muscle M may further include a connection member 9. The connection member 9 may couple a soft actuator to a human body HF. The connection member 9 may include a first connection member 91 and a second connection member 93.

The first connection member 91 may be coupled to a first support body 11. The first connection member 91 may be fixed to one side of the human body HF. The first connection member 91 may have a ring shape as illustrated in FIG. 9, but is not limited thereto.

The second connection member 93 may be coupled to a second support body 13. The second connection member 93 may be fixed to one side of the human body HF. The second connection member 93 may have a ring shape as illustrated in FIG. 9, but is not limited thereto.

According to the soft actuator, the artificial muscle including the same, and the artificial muscle driving method using the same according to embodiments of the inventive concept, one side of the artificial muscle may be fixed to one side of the human body, and the other side of the artificial muscle may be fixed to the other side of the human body. If the soft actuator is contracted in this state, a portion of the human body may be moved. For example, as illustrated in FIG. 9, when the soft actuator is contracted while the artificial muscle is coupled to a finger joint of the human body, the finger joint may be bent.

Although the above has been illustrated and described based on the artificial muscles used on the fingers of the human body, the embodiment of the inventive concept is not limited thereto. That is, the artificial muscle according to the inventive concept may be applied to other joints.

According to the soft actuator, the artificial muscle including the same, and the artificial muscle driving method using the same according to the embodiment, the soft actuator may be precisely controlled.

According to the soft actuator, the artificial muscle including the same, and the artificial muscle driving method using the same according to the embodiment, the soft actuator may have the small volume and be slim.

According to the soft actuator, the artificial muscle including the same, and the artificial muscle driving method using the same according to the embodiment, the soft actuator may be bent with the plurality of curvatures.

The effects of the present invention are not limited to the aforementioned objects, but other effects not described herein will be clearly understood by those skilled in the art from descriptions below.

Although the embodiment of the present invention is described with reference to the accompanying drawings, those with ordinary skill in the technical field of the present invention pertains will be understood that the present invention can be carried out in other specific forms without changing the technical idea or essential features. Thus, the above-disclosed embodiments are to be considered illustrative and not restrictive.

What is claimed is:

1. A soft actuator comprising:
a first support body;
a second support body spaced apart from the first support body in a first direction;
a yarn structure having one end coupled to the first support body and the other end coupled to the second support body; and
a light source part spaced apart from the yarn structure in a second direction crossing the first direction,
wherein the yarn structure comprises:
a polymer layer having a coil spring shape extending in the first direction; and
a light absorption layer configured to surround an outer surface of the polymer layer.

2. The soft actuator of claim 1, wherein the polymer layer comprises at least one of nylon, polyvinyl alcohol (PVA), cotton, silk, or cellulose.

3. The soft actuator of claim 1, wherein the light absorption layer comprises poly(3,4-ethylenedioxythiophene) (PEDOT) doped with p-toluenesulfonate (PEDOT-Tos).

4. The soft actuator of claim 1, wherein the light source part comprises a plurality of LED light sources,
wherein the plurality of LED light sources are arranged in the first direction.

5. The soft actuator of claim 1, wherein the yarn structure is provided in plurality,
wherein the plurality of yarn structures are disposed to be spaced apart from each other in a third direction crossing each of the first direction and the second direction.

6. The soft actuator of claim 1, further comprising a reflective cover extending from the first support body to the second support body,
wherein the reflective cover is configured to surround the yarn structure and the light source.

7. The soft actuator of claim 6, wherein the reflective cover comprises:
an elastic polymer layer configured to define an inner space in which the yarn structure and the light source are disposed; and
a light reflective layer on an outer surface of the elastic polymer layer.

8. The soft actuator of claim 7, wherein the elastic polymer layer comprises polydimethylsiloxane (PDMS).

9. An artificial muscle comprising:
a soft actuator; and
a connection member configured to couple the soft actuator to a human body,
wherein the soft actuator comprises:
a first support body;
a second support body spaced apart from the first support body in a first direction;
a yarn structure extending from the first support body toward the second support body, the yarn structure having a coil spring shape; and
a light source part spaced apart from the yarn structure in a second direction crossing the first direction,
wherein the connection member comprises:
a first connection member coupled to the first support body; and
a second connection member coupled to the second support body.

10. The artificial muscle of claim 9, wherein the yarn structure comprises:
a polymer layer having a coil spring shape extending in the first direction; and
a light absorption layer configured to surround an outer surface of the polymer layer.

11. The artificial muscle of claim 10, wherein the polymer layer comprises at least one of nylon, polyvinyl alcohol (PVA), cotton, silk, or cellulose, and
the light absorption layer comprises poly(3,4-ethylenedioxythiophene) (PEDOT) doped with p-toluenesulfonate (PEDOT-Tos).

12. The artificial muscle of claim 9, wherein each of the first connection member and the second connection member has a ring shape.

13. The artificial muscle of claim 9, wherein the light source part comprises a plurality of LED light sources,
wherein the plurality of LED light sources are arranged in the first direction.

14. An artificial muscle driving method comprising:
irradiating light to a yarn structure from a light source part;
allowing a light absorption layer of the yarn structure to absorb the light so as to generate heat; and
heating a polymer layer of the yarn structure by the heat emitted from the light absorption layer to contract a length of the polymer layer,
wherein the polymer layer has a coil spring shape extending in a first direction, and
the light absorption layer is configured to surround the polymer layer.

15. The artificial muscle driving method of claim 14, wherein the light source part is spaced apart from the yarn structure in a second direction crossing the first direction.

16. The artificial muscle driving method of claim 14, wherein the polymer layer comprises at least one of nylon, polyvinyl alcohol (PVA), cotton, silk, or cellulose, and
the light absorption layer comprises poly(3,4-ethylenedioxythiophene) (PEDOT) doped with p-toluenesulfonate (PEDOT-Tos).
